(19) United States
(12) Patent Application Publication
(10) Pub. No.: US 2012/0134015 A1
(43) Pub. Date: May 31, 2012

(54) MIRROR FOR EUV WAVELENGTHS, PROJECTION OBJECTIVE FOR MICROLITHOGRAPHY HAVING SUCH MIRROR AND PROJECTION EXPOSURE APPARATUS HAVING SUCH PROJECTION OBJECTIVE

(75) Inventors: Hans-Jochen PAUL, Aalen (DE); Gerhard BRAUN, Ederheim (DE); Sascha MIGURA, Aalen-Unterrombach (DE); Aurelian DODOC, Heidenheim (DE); Christoph ZACZEK, Heubach (DE)

(73) Assignee: CARL ZEISS SMT GMBH, Oberkochen (DE)

(21) Appl. No.: 13/274,006

(22) Filed: Oct. 14, 2011

Related U.S. Application Data
(63) Continuation of application No. PCT/EP2010/053633, filed on Mar. 19, 2010.
(60) Provisional application No. 61/219,583, filed on Jun. 23, 2009.

(30) Foreign Application Priority Data
Apr. 15, 2009 (DE) 10 2009 017 095.2

(51) Int. Cl. G02B 5/08

(52) U.S. Cl. 359/359

(57) ABSTRACT

EUV mirror with a layer arrangement on a substrate. The layer arrangement includes a plurality of layer subsystems each consisting of a periodic sequence of at least one period of individual layers. The periods include two individual layers composed of different material for a high refractive index layer and a low refractive index layer and have within each subsystem a constant thickness that deviates from a period thickness of an adjacent layer subsystem. The subsystem most distant from the substrate has (i) a number of periods greater than the number of periods for the layer subsystem that is second most distant from the substrate and/or (ii) a thickness of the high refractive index layer that deviates by more than 0.1 nm from that of the high refractive index layer of the subsystem that is second most distant from the substrate.

### CROSS-REFERENCE TO RELATED APPLICATIONS

This is a Continuation of International Application PCT/EP2010/053633, with an international filing date of Mar. 19, 2010, which was published under PCT Article 21(2) in English, and which claims priority to German Patent Application No. 10 2009 017 095.2, filed on Apr. 15, 2009, as well as to U.S. Provisional Application No. 61/219,583, filed on Jun. 23, 2009. The entire disclosures of all these applications are incorporated into this application by reference.

### FIELD OF AND BACKGROUND OF THE INVENTION

The invention relates to a mirror for the EUV wavelength range. Furthermore, the invention relates to a projection objective for microlithography comprising such a mirror. Moreover, the invention relates to a projection exposure apparatus for microlithography comprising such a projection objective.

Projection exposure apparatuses for microlithography for the EUV wavelength range have to rely on the assumption that the mirrors used for the exposure or imaging of a mask into an image plane have a high reflectivity since, firstly, the product of the reflectivity values of the individual mirrors determines the total transmission of the projection exposure apparatus and since, secondly, the light power of EUV light sources is limited.

Mirrors for the EUV wavelength range around 13 nm having high reflectivity values are known from DE 101 55 711 A1, for example. The mirrors described therein consist of a layer arrangement which is applied on a substrate and which has a sequence of individual layers, wherein the layer arrangement comprises a plurality of layer subsystems each having a periodic sequence of at least two individual layers of different materials that form a period, wherein the number of periods and the thickness of the periods of the individual subsystems decrease from the substrate toward the surface. Such mirrors have a reflectivity of greater than 30% in the case of an angle of incidence interval of between 0° and 20°.

### OBJECTS AND SUMMARY OF THE INVENTION

What is disadvantageous about these layers, however, is that their reflectivity in the angle of incidence interval specified is not constant, but rather varies greatly. A high variation of the reflectivity of a mirror over the angles of incidence is disadvantageous, however, for the use of such a mirror at locations with high angles of incidence and with high angle of incidence changes in a projection objective or a projection exposure apparatus for microlithography since such a variation leads for example to an excessively large variation of the pupil apodization of such a projection objective or such a projection exposure apparatus. In this case, the pupil apodization is a measure of the intensity fluctuation over the exit pupil of a projection objective.

It is an object of the invention, therefore, to provide a mirror for the EUV wavelength range which can be used at locations with high angles of incidence and high angle of incidence change within a projection objective or projection exposure apparatus and at the same time avoids the abovementioned disadvantages of the prior art.

This object is achieved, according to one formulation of the invention, by a mirror for the EUV wavelength range comprising a layer arrangement applied on a substrate, wherein the layer arrangement comprises a plurality of layer subsystems. In this case, the layer subsystems each consist of a periodic sequence of at least one period of individual layers. In this case, the periods comprise two individual layers composed of different material for a high refractive index layer and a low refractive index layer and have within each layer subsystem a constant thickness that deviates from a thickness of the periods of an adjacent layer subsystem. In this case the layer subsystem that is most distant from the substrate has a number of periods that is greater than the number of periods for the layer subsystem that is second most distant from the substrate and/or the layer subsystem that is most distant from the substrate has a thickness of the high refractive index layer that deviates by more than 0.1 nm from the thickness of the high refractive index layer of the layer subsystem that is second most distant from the substrate. In this case, the layer subsystems of the layer arrangement of the mirror succeed one another directly and are not separated by a further layer subsystem. However, separation of the layer subsystems by an individual interlayer is conceivable for adapting the layer subsystems to one another or for optimizing the optical properties of the layer arrangement.

It has been recognized that, in order to achieve a high and uniform reflectivity across a large angle of incidence interval, the number of periods for the layer subsystem that is most distant from the substrate must be greater than that for the layer subsystem that is second most distant from the substrate. In addition or as an alternative to this, in order to achieve a high and uniform reflectivity across a large angle of incidence interval, the thickness of the high refractive index layer for the layer subsystem that is most distant from the substrate should deviate by more than 0.1 nm from the thickness of the high refractive index layer of the layer subsystem that is second most distant from the substrate.

In this case, it is advantageous for production engineering reasons if the layer subsystems are in this case all constructed from the same materials since this simplifies the production of such mirrors.

Furthermore, it is possible to achieve particularly high reflectivity values in the case of a small number of layer subsystems if, in this case, the layer subsystem that is most distant from the substrate has a thickness of the high refractive index layer that amounts to more than double the thickness of the high refractive index layer of the layer subsystem that is second most distant from the substrate.

Furthermore, the object is achieved by a mirror, according to another formulation of the invention, for the EUV wavelength range comprising a layer arrangement applied on a substrate, wherein the layer arrangement comprises a plurality of layer subsystems. In this case, the layer subsystems each consist of a periodic sequence of at least one period of individual layers. In this case, the periods comprise two individual layers composed of different material for a high refractive index layer and a low refractive index layer and have within each layer subsystem a constant thickness that deviates from a thickness of the periods of an adjacent layer subsystem. In this case, the mirror, at a wavelength of 13.5 nm, has a reflectivity of more than 35% and a variation of the reflectivity as PV value of less than or equal to 0.25, in particular less than or equal to 0.23, for an angle of incidence interval selected as an angle of incidence interval from the group of angle of incidence intervals: from 0° to 30°, from 17.8° to 27.2°, from 14.1° to 25.7°, from 8.7° to 21.4°, and from 2.5° to 7.3°.

In this case, the PV value is defined as the difference between the maximum reflectivity Rₘₐₓ and the minimum reflectivity Rₘᵢₙ in the angle of incidence interval under consideration divided by the average reflectivity R_{average} in the angle of incidence interval under consideration. Consequently, PV=(Rₘₐₓ−Rₘᵢₙ)/R_{average} holds true. In this case, the angle of incidence interval is deemed to be the angular range between the maximum angle of incidence and the minimum angle of incidence which has to be ensured by a layer design for a given distance from the optical axis on account of the optical design. This angle of incidence interval will also be abbreviated to AOI interval.

It has been recognized that, in order to achieve a low pupil apodization of a projection objective comprising a mirror for the EUV wavelength range which is used at locations having high angles of incidence and a high variation of angles of incidence within the projection objective, the so-called PV value of the reflectivity as a measure of the variation of the reflectivity over the angles of incidence of such a mirror should not exceed a certain value for certain angle of incidence intervals.

In this case, it should be taken into consideration that high PV values of mirrors of a projection objective which are used at locations having high angles of incidence and a high variation of the angles of incidence dominate the imaging aberration of the pupil apodization of the projection objective relative to other causes of aberration, such that for high PV values of these mirrors there is a 1:1 correlation with the imaging aberration of the pupil apodization of the projection objective. This correlation occurs approximately starting from a value of 0.25 for the PV value of such a mirror within a projection objective for EUV microlithography.

Advantageously, the layer arrangement of a mirror comprises at least three layer subsystems, wherein the number of periods of the layer subsystem that is situated closest to the substrate is greater than for the layer subsystem that is most distant from the substrate. Furthermore, it is advantageous if the layer arrangement comprises at least three layer subsystems and the number of periods of the layer subsystem that is situated closest to the substrate is greater than for the layer subsystem that is second most distant from the substrate. These measures foster a decoupling of the reflection properties of the mirror from deeper layers or the substrate, such that it is possible to use other layers with other functional properties or other substrate materials below the layer arrangement of the mirror.

A mirror for the EUV wavelength range in which the number of periods of the layer subsystem that is most distant from the substrate corresponds to a value of between 9 and 16, and a mirror for the EUV wavelength range in which the number of periods of the layer subsystem that is second most distant from the substrate corresponds to a value of between 2 and 12, lead to a limitation of the layers required in total for the mirror and thus to a reduction of the complexity and the risk during the production of the mirror.

It is advantageous for a mirror for the EUV wavelength range if the thickness of periods for the layer subsystem that is most distant from the substrate amounts to between 7.2 nm and 7.7 nm. It is likewise advantageous if the thickness of the high refractive index layer of periods for the layer subsystem that is most distant from the substrate is greater than 3.4 nm. It is thereby possible to realize particularly high uniform reflectivity values for large angle of incidence intervals.

A mirror for the EUV wavelength range in which the thickness of the low refractive index layer of periods for the layer subsystem that is most distant from the substrate is less than two thirds of the thickness of the low refractive index layer of periods for the layer subsystem that is second most distant from the substrate, and a mirror for the EUV wavelength range in which the thickness of the low refractive index layer of periods for the layer subsystem that is second most distant from the substrate is greater than 5 nm, afford the advantage that the layer design can be adapted not only with regard to the reflectivity per se, but also with regard to the reflectivity of s-polarized light with respect to the reflectivity of p-polarized light over the angle of incidence intervals striven for.

Furthermore, it is advantageous if the two individual layers that form a period consist of the materials molybdenum Mo and silicon Si or ruthenium Ru and silicon Si. It is thereby possible to achieve particularly high reflectivity values and at the same time to realize production engineering advantages since only two different materials are used for producing the layer subsystems of the layer arrangement of the mirror. In this case, it is advantageous if the individual layers are separated by at least one barrier layer and the barrier layer consists of a material or a compound which is selected from or which is composed of the group of materials: B₄C, C, Si nitride, Si carbide, Si boride, Mo nitride, Mo carbide, Mo boride, Ru nitride, Ru carbide and Ru boride. Such a barrier layer suppresses the interdiffusion between the two individual layers of a period, thereby increasing the optical contrast in the transition of the two individual layers. With the use of the materials molybdenum Mo and silicon Si for the two individual layers of a period, one barrier layer between the Mo layer and the Si layer suffices in order to provide for a sufficient contrast. The second barrier layer between the Si layer of one period and the Mo layer of the adjacent period can be dispensed with in this case. In this respect, at least one barrier layer for separating the two individual layers of a period should be provided, wherein the at least one barrier layer may perfectly well be constructed from various ones of the above-indicated materials or the compounds thereof and may in this case also exhibit a layered construction of different materials or compounds.

Advantageously, a mirror according to one aspect of the invention comprises a covering layer system comprising at least one layer composed of a chemically inert material, which terminates the layer arrangement of the mirror. The mirror is thereby protected against ambient influences.

Moreover, it is advantageous if the mirror according to another aspect of the invention assumes a thickness factor of the layer arrangement along the mirror surface having values of between 0.9 and 1.05, in particular having values of between 0.933 and 1.018. It is thereby possible for different locations of the mirror surface to be adapted in a more targeted fashion to different angles of incidence that are to be ensured there.

In this case, the thickness factor is the factor with which the thicknesses of the layers of a given layer design, in multiplied fashion, are realized at a location on the substrate. A thickness factor of 1 thus corresponds to the nominal layer design.

The thickness factor as a further degree of freedom makes it possible for different locations of the mirror to be adapted in a more targeted fashion to different angle of incidence intervals that occur there, without the layer design of the mirror per se having to be changed, with the result that the mirror ultimately yields, for higher angle of incidence intervals across different locations on the mirror, higher reflectivity values than are permitted by the associated layer design per se. By adapting the thickness factor, it is thus also possible, over and above ensuring high angles of incidence, to achieve a further reduction of the variation of the reflectivity of the mirror over the angles of incidence.

In this case, it is advantageous if the thickness factor of the layer arrangement at a location of the mirror surface correlates with the maximum angle of incidence that is to be ensured there, since, for a higher maximum angle of incidence to be ensured, a larger thickness factor is necessary for the adaptation.

Furthermore, the object is attained by a projection objective comprising at least one mirror according to the invention as well as by a projection exposure apparatus according to the invention for microlithography comprising such a projection objective.

Further features and advantages of the invention will become apparent from the following description of exemplary embodiments of the invention with reference to the figures, which show details associated with the invention, and from the claims. The individual features can be realized in each case individually by themselves or as a plurality in any desired combination as variants falling within the scope of the invention.

### BRIEF DESCRIPTION OF THE DRAWINGS

Exemplary embodiments of the invention are explained in greater detail below with reference to the figures, in which:

FIG. 1 shows a schematic illustration of a mirror configured in accordance with the invention;

FIG. 2 shows a schematic illustration of a further mirror configured in accordance with the invention;

FIG. 3 shows a schematic illustration of a projection objective configured in accordance with the invention for a projection exposure apparatus for microlithography;

FIG. 4 shows a schematic illustration of the image field of the projection objective;

FIG. 5 shows an exemplary illustration of the maximum angles of incidence and the interval lengths of the angle of incidence intervals against the distance of the locations of a mirror configured in accordance with the invention with respect to the optical axis within a projection objective;

FIG. 6 shows a schematic illustration of the optically utilized region (hatched) on the substrate of a mirror configured in accordance with the invention;

FIG. 7 shows a schematic illustration of various reflectivity values of a mirror in accordance with a first exemplary embodiment versus the angles of incidence;

FIG. 8 shows a schematic illustration of further reflectivity values of a mirror in accordance with the first exemplary embodiment versus the angles of incidence;

FIG. 9 shows a schematic illustration of various reflectivity values of a mirror in accordance with a second exemplary embodiment versus the angles of incidence; and

FIG. 10 shows a schematic illustration of further reflectivity values of a mirror in accordance with the second exemplary embodiment versus the angles of incidence.

### DETAILED DESCRIPTION OF EXEMPLARY EMBODIMENTS

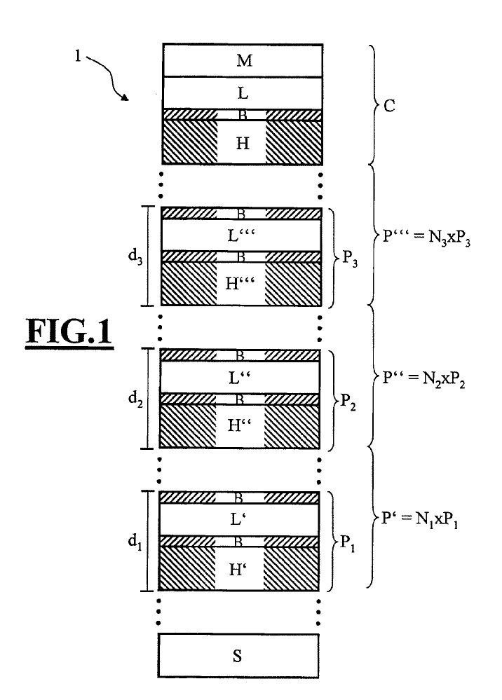

FIG. 1 shows a schematic illustration of a mirror 1 according to an exemplary embodiment of the invention for the EUV wavelength range comprising a layer arrangement which is applied on a substrate S and which has a sequence of individual layers. In this case, the layer arrangement comprises a plurality of layer subsystems P′, P″ and P″′ each having a periodic sequence of at least two individual layers—forming a period P₁, P₂ and P₃—of different materials H′, L′; H″, L″ and H′″, L′″. Furthermore, the periods P₁, P₂ and P₃ have within each layer subsystem P′, P″ and P′″ in FIG. 1 a constant thickness d₁, d₂ and d₃ that deviates from a thickness of the periods of adjacent layer subsystems. In this case, the layer subsystem P′″ that is most distant from the substrate has a number N₃ of periods P₃ that is greater than the number N₂ of periods P₂ for the layer subsystem P″ that is second most distant from the substrate.

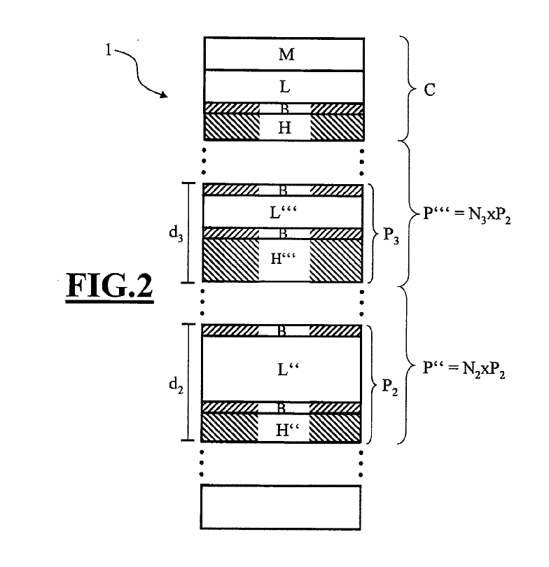

FIG. 2 shows a schematic illustration of a further mirror 1 in accordance with the invention for the EUV wavelength range comprising a layer arrangement which is applied on a substrate S and which has a sequence of individual layers. In this case, the layer arrangement comprises a plurality of layer subsystems P″ and P′″ each having a periodic sequence of at least two individual layers—forming a period P₂ and P₃—of different materials H″, L″ and H′″, L′″. Furthermore, the periods P₂ and P₃ have within each layer subsystem P″ and P′″ in FIG. 1 a constant thickness d₂ and d₃ that deviates from a thickness of the periods of adjacent layer subsystems. In this case, the layer subsystem P′″ that is most distant from the substrate has a number N₃ of periods P₃ that is greater than the number N₂ of periods P₂ for the layer subsystem P″ that is second most distant from the substrate. As an alternative or at the same time, the layer subsystem P′″ that is most distant from the substrate has a thickness of the high refractive index layers H′″ that deviates by more than 0.1 nm from the thickness of the high refractive index layers H″ of the layer subsystem P″ that is second most distant from the substrates. In particular in the case of a small number of layer subsystems of just two layer subsystems, for example, it is found that high reflectivity values are achieved if the layer subsystem P′″ that is most distant from the substrate has a thickness of the high refractive index layer H′″ that amounts to more than double the thickness of the high refractive index layer H″ of the layer subsystem P″ that is second most distant from the substrate.

The layer subsystems of the layer arrangement of the mirrors with respect to FIG. 1 and FIG. 2 succeed one another directly and are not separated by a further layer subsystem. However, separation of the layer subsystems by an individual interlayer is conceivable for adapting the layer subsystems to one another or for optimizing the optical properties of the layer arrangement.

The layers designated by H, H′, H″ and H′″ in FIG. 1 and FIG. 2 are layers composed of materials which, in the EUV wavelength range, can be designated as high refractive index layers in comparison with the layers of the same layer subsystem which are designated as L, L′, L″ and L′″, see the complex refractive indices of the materials in table 2. Conversely, the layers designated by L, L′, L″ and L′″ in FIG. 1 and FIG. 2 are layers composed of materials which, in the EUV wavelength range, can be designated as low refractive index layers in comparison with the layers of the same layer subsystem which are designated as H, H′, H″ and H′″. Consequently, the terms high refractive index and low refractive index in the EUV wavelength range are relative terms with regard to the respective partner layer in a period of a layer subsystem. Layer subsystems function in the EUV wavelength range generally only if a layer that acts optically with a high refractive index is combined with a layer that optically has a lower refractive index relative thereto, as main constituent of a period of the layer subsystem. The material silicon is generally used for high refractive index layers. In combination with silicon, the materials molybdenum and ruthenium should be designated as low refractive index layers, see the complex refractive indices of the materials in table 2.

In FIG. 1 and FIG. 2, a barrier layer B is in each case situated between the individual layers composed of silicon Si and molybdenum Mo, and silicon Si and ruthenium Ru, respectively. In this case, it is advantageous if the barrier layer consists of a material or a compound which is selected from or which is composed of the group of materials: B₄C, C, Si nitride, Si carbide, Si boride, Mo nitride, Mo carbide, Mo boride, Ru nitride, Ru carbide and Ru boride. Such a barrier layer suppresses the interdiffusion between the two individual layers of a period, thereby increasing the optical contrast in the transition of the two individual layers. With the use of the materials molybdenum Mo and silicon Si for the two individual layers of a period, one barrier layer between the Mo layer and the Si layer suffices in order to provide for a sufficient contrast. The second barrier layer between the Si layer of one period and the Mo layer of the adjacent period can be dispensed with in this case. In this respect, at least one barrier layer for separating the two individual layers of a period should be provided, wherein the at least one barrier layer may perfectly well be constructed from various ones of the above-indicated materials or the compounds thereof and may in this case also exhibit a layered construction of different materials or compounds.

In the case of the mirror 1, the number N₁, N₂ and N₃ of periods P₁, P₂ and P₃ of the layer subsystems P′, P″ and P′″ can comprise in each case up to 100 periods of the individual periods P₁, P₂ and P₃ illustrated in FIG. 1 and FIG. 2. Furthermore, between the layer arrangement illustrated in FIG. 1 and FIG. 2 and the substrate S an interlayer or an interlayer arrangement can be provided, which serves for the stress compensation of the layer arrangement. The same materials as for the layer arrangement itself can be used as materials for the interlayer or the interlayer arrangement. In the case of the interlayer arrangement, it is possible to dispense with the barrier layer between the individual layers since the interlayer or the interlayer arrangement generally makes a negligible contribution to the reflectivity of the mirror and so the issue of an increase in contrast by the barrier layer is unimportant in this case. Cr/Sc multilayer arrangements or amorphous Mo or Ru layers would likewise be conceivable as the interlayer or interlayer arrangement.

The layer arrangement of the mirror 1 is terminated in FIG. 1 and FIG. 2 by a covering layer system C comprising at least one layer composed of a chemically inert material such as e.g. Rh, Pt, Ru, Pd, Au, SiO2, etc. as a terminating layer M. Said terminating layer M thus prevents the chemical alteration of the mirror surface on account of ambient influences.

The thickness of one of the periods P₁, P₂ and P₃ results from FIG. 1 and FIG. 2 as the sum of the thicknesses of the individual layers of the corresponding period, that is to say from the thickness of the high refractive index layer, the thickness of the low refractive index layer and the thickness of two barrier layers. Consequently, the layer subsystems P′, P″ and P′″ in FIG. 1 and FIG. 2 can be distinguished from one another by virtue of the fact that their periods P₁, P₂ and P₃ have a different thickness d₁, d₂ and d₃. Consequently, in the context of the present invention, different layer subsystems P′, P″ and P′″ are understood to be layer subsystems whose periods P₁, P₂ and P₃ differ by more than 0.1 nm in their thicknesses d₁, d₂ and d₃, since a different optical effect of the layer subsystems can no longer be assumed below a difference of 0.1 nm. Furthermore, coherently identical layer subsystems can fluctuate by this absolute value in their period thickness during their production on different production apparatuses. For the case of a layer subsystem P′, P″ and P′″ having a period composed of molybdenum and silicon, it is also possible, as already described above, to dispense with the second barrier layer within the period P₁, P₂ and P₃, such that in this case the thickness of the periods P₁, P₂ and P₃ results from the thickness of the high refractive index layer, the thickness of the low refractive index layer and the thickness of a barrier layer.

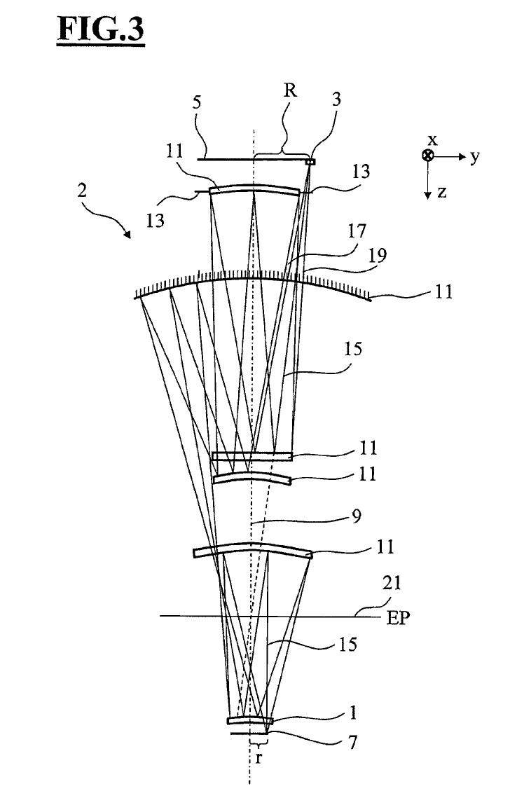

FIG. 3 shows a schematic illustration of a projection objective 2 according to a further embodiment of the invention for a projection exposure apparatus for microlithography having six mirrors 1, 11, including at least one mirror 1 in accordance with the invention. The task of a projection exposure apparatus for microlithography is to image the structures of a mask, which is also referred to as a reticle, lithographically onto a so-called wafer in an image plane. For this purpose, a projection objective 2 in FIG. 3 images an object field 3, which is arranged in the object plane 5, into an image field in the image plane 7. The structure-bearing mask, which is not illustrated in the drawing for the sake of clarity, can be arranged at the location of the object field 3 in the object plane 5. For orientation purposes, FIG. 3 illustrates a system of Cartesian coordinates, the x-axis of which points into the plane of the figure. In this case, the x-y coordinate plane coincides with the object plane 5, the z-axis being perpendicular to the object plane 5 and pointing downward. The projection objective has an optical axis 9, which does not run through the object field 3. The mirrors 1, 11 of the projection objective 2 have a design surface that is rotationally symmetrical with respect to the optical axis. In this case, said design surface must not be confused with the physical surface of a finished mirror, since the latter surface is trimmed relative to the design surface in order to ensure passages of light past the mirror. In this exemplary embodiment, the aperture stop 13 is arranged on the second mirror 11 in the light path from the object plane 5 to the image plane 7. The effect of the projection objective 2 is illustrated with the aid of three rays, the principal ray 15 and the two aperture marginal rays 17 and 19, all of which originate in the center of the object field 3. The principal ray 15, which runs at an angle of 6° with respect to the perpendicular to the object plane, intersects the optical axis 9 in the plane of the aperture stop 13. As viewed from the object plane 5, the principal ray 15 appears to intersect the optical axis in the entrance pupil plane 21. This is indicated in FIG. 3 by the dashed extension of the principal ray 15 through the first mirror 11. Consequently, the virtual image of the aperture stop 13, the entrance pupil, lies in the entrance pupil plane 21. The exit pupil of the projection objective could likewise be found with the same construction in the backward extension of the principal ray 15 proceeding from the image plane 7. However, in the image plane 7 the principal ray 15 is parallel to the optical axis 9, and from this it follows that the backward projection of these two rays produces a point of intersection at infinity in front of the projection objective 2 and the exit pupil of the projection objective 2 is thus at infinity. Therefore, this projection objective 2 is a so-called objective that is telecentric on the image side. The center of the object field 3 is at a distance R from the optical axis 9 and the center of the image field 7 is at a distance r from the optical axis 9, in order that no undesirable vignetting of the radiation emerging from the object field occurs in the case of the reflective configuration of the projection objective.

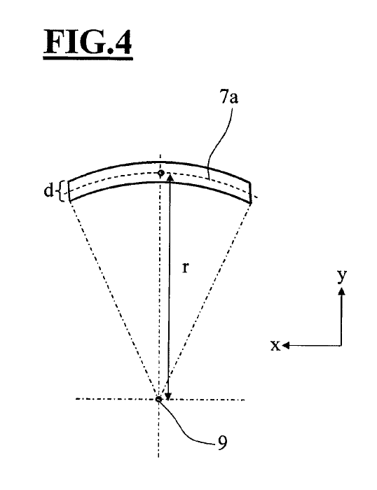

FIG. 4 shows a plan view of an arcuate image field 7a such as occurs in the projection objective 2 illustrated in FIG. 3, and a system of Cartesian coordinates, the axes of which correspond to those from FIG. 3. The image field 7a is a sector from an annulus, the center of which is through the point of intersection of the optical axis 9 with the object plane. The average radius r is 34 mm in the case illustrated. The width of the field in the y-direction d is 2 mm here. The central field point of the image field 7a is marked as a small circle within the image field 7a. As an alternative, a curved image field can also be delimited by two circle arcs which have the same radius and are displaced relative to one another in the y-direction. If the projection exposure apparatus is operated as a scanner, then the scanning direction runs in the direction of the shorter extent of the object field, that is to say in the direction of the y-direction.

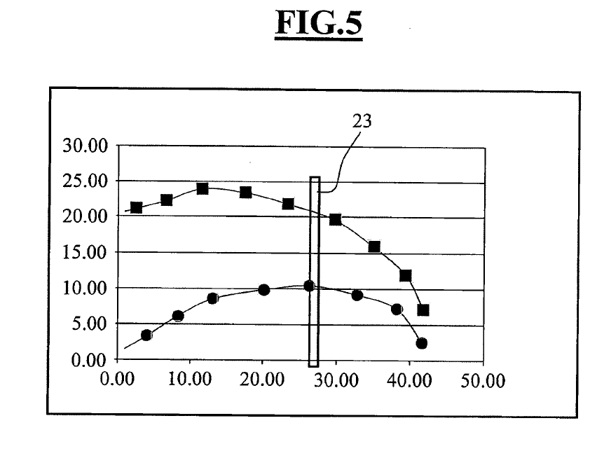

FIG. 5 shows an exemplary illustration of the maximum angles of incidence (rectangles) and of the interval lengths of the angle of incidence intervals (circles) in the unit degrees [°] against different radii or distances between the locations and the optical axis, indicated in the unit [mm], of the penultimate mirror 1 in the light path from the object plane 5 to the image plane 7 of the projection objective 2 from FIG. 3. Said mirror 1, in the case of a projection objective for microlithography 2 which has six mirrors for the EUV wavelength range 1, 11, is generally that mirror which has to ensure the largest angles of incidence and the largest angle of incidence intervals or the greatest variation of angles of incidence. In the context of this application, the interval length of an angle of incidence interval as a measure of the variation of angles of incidence is understood to be the number of angular degrees of that angular range in degrees between the maximum and minimum angles of incidence which the coating of the mirror has to ensure for a given distance from the optical axis on account of the requirements of the optical design.

The optical data of the projection objective in accordance with table 1 are applicable in the case of the mirror 1 on which FIG. 5 is based. In this case, the aspheres Z(h) of the mirrors 1, 11 of the optical design are given as a function of the distance h between an asphere point of the individual mirror and the optical axis, indicated in the unit [mm], in accordance with the asphere equation:

Z(h)=(rho*h²)/(1+[1−(1+k_{y})*(rho*h)²]^{0.5})+c₁*h⁴+c₂*h⁶+c₃*h⁸+c₄*h¹⁰+c₅*h¹²+c₆*h¹⁴

with the radius R=1/rho of the mirror and the parameters k_{y}, c₁, c₂, c₃, c₄, c₅, and c₆. In this case, said parameters cₙ are normalized with regard to the unit [mm] in accordance with [1/mm²ⁿ⁺²] in such a way as to result in the asphere Z(h) as a function of the distance h also in the unit [mm].

TABLE 1
Data of the optical design regarding the angles of incidence of the mirror 1 in FIG. 5 in
accordance with the schematic illustration of the design on the basis of FIG. 2.

| Designation of | | | |
|---|---|---|---|
| the surface in | | Distance from the | Asphere parameters with the |
| accordance | | nearest surface in | unit |
| with FIG. 2 | Radius R in [mm] | [mm] | [1/mm²ⁿ⁺²] for cₙ |
| Object plane 5 | Infinity | 697.657821079643 | |
| 1st mirror 11 | −3060.189398512395 | 494.429629463009 | |
| | | | k_{y} = 0.00000000000000E+00 |
| | | | c₁ = 8.46747658600840E−10 |
| | | | c₂ = −6.38829035308911E−15 |
| | | | c₃ = 2.99297298249148E−20 |
| | | | c₄ = 4.89923345704506E−25 |
| | | | c₅ = −2.62811636654902E−29 |
| | | | c₆ = 4.29534493103729E−34 |
| 2nd mirror 11 -- | −1237.831140064837 | 716.403660000000 | |
| diaphragm | | | |
| | | | k_{y} = 3.05349335818189E+00 |
| | | | c₁ = 3.01069673080653E−10 |
| | | | c₂ = 3.09241275151742E−16 |
| | | | c₃ = 2.71009214786939E−20 |
| | | | c₄ = −5.04344434347305E−24 |
| | | | c₅ = 4.22176379615477E−28 |
| | | | c₆ = −1.41314914233702E−32 |
| 3rd mirror 11 | 318.277985359899 | 218.770165786534 | |
| | | | k_{y} = −7.80082610035452E−01 |
| | | | c₁ = 3.12944645776932E−10 |
| | | | c₂ = −1.32434614339199E−14 |
| | | | c₃ = 9.56932396033676E−19 |
| | | | c₄ = −3.13223523243916E−23 |
| | | | c₅ = 4.73030659773901E−28 |
| | | | c₆ = −2.70237216494288E−33 |
| 4th mirror 11 | −513.327287349838 | 892.674538915941 | |
| | | | k_{y} = −1.05007411819774E−01 |
| | | | c₁ = −1.33355977877878E−12 |
| | | | c₂ = −1.71866358951357E−16 |
| | | | c₃ = 6.69985430179187E−22 |
| | | | c₄ = 5.40777151247246E−27 |
| | | | c₅ = −1.16662974927332E−31 |
| | | | c₆ = 4.19572235940121E−37 |
| Mirror 1 | 378.800274177878 | 285.840721874570 | |
| | | | k_{y} = 0.00000000000000E+00 |
| | | | c₁ = 9.27754883183223E−09 |
| | | | c₂ = 5.96362556484499E−13 |
| | | | c₃ = 1.56339572303953E−17 |
| | | | c₄ = −1.41168321383233E−21 |
| | | | c₅ = 5.98677250336455E−25 |
| | | | c₆ = −6.30124060830317E−29 |
| 5th mirror 11 | −367.938526548613 | 325.746354374172 | |
| | | | k_{y} = 1.07407597789597E−01 |
| | | | c₁ = 3.87917960004046E−11 |
| | | | c₂ = −3.43420257078373E−17 |
| | | | c₃ = 2.26996395088275E−21 |
| | | | c₄ = −2.71360350994977E−25 |
| | | | c₅ = 9.23791176750829E−30 |
| | | | c₆ = −1.37746833100643E−34 |
| Image plane 7 | Infinity | | |

It can be discerned from FIG. 5 that maximum angles of incidence of 24° and interval lengths of 11° occur at different locations of the mirror 1. Consequently, the layer arrangement of the mirror 1 has to yield high and uniform reflectivity values at these different locations for different angles of incidence and different angle-of incidence intervals, since otherwise a high total transmission and an acceptable pupil apodization of the projection objective 2 cannot be ensured. In this case, it should be taken into consideration that high PV values for a mirror 1 of the projection objective 2 as penultimate mirror before the image plane 7 in accordance with FIG. 2 and the design in table 1 lead to high values for the pupil apodization. In this case, there is a 1:1 correlation between the PV value of the mirror 1 and the imaging aberration of the pupil apodization of the projection objective 2 for high PV values of greater than 0.25.

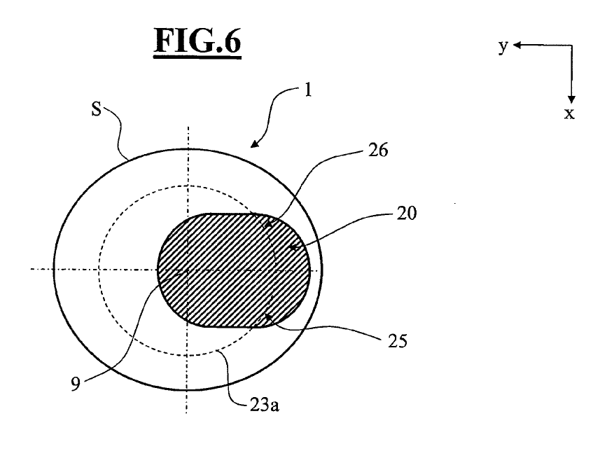

In FIG. 5, a bar 23 is used to mark by way of example a specific radius or a specific distance of the locations of the mirror 1 having the associated maximum angle of incidence of approximately 21° and the associated interval length of 11° with respect to the optical axis. Said marked radius corresponds in FIG. 6 to the locations on the circle 23a—illustrated in dashed fashion—within the hatched region 20, which represents the optically utilized region 20 of the mirror 1.

FIG. 6 shows the complete substrate S of the penultimate mirror 1 in the light path from the object plane 5 to the image plane 7 of the projection objective 2 from FIG. 3 as a solid circle centered with respect to the optical axis 9 in plan view. In this case, the optical axis 9 of the projection objective 2 corresponds to the axis 9 of symmetry of the substrate. Furthermore, in FIG. 6, the optically utilized region 20 of the mirror 1, said region being offset with respect to the optical axis, is depicted in hatched fashion and a circle 23a is depicted in dashed fashion.

In this case, the part of the dashed circle 23a within the optically utilized region corresponds to the locations of the mirror 1 which are identified by the depicted bar 23 in FIG. 5. Consequently, the layer arrangement of the mirror 1 along the partial region of the dashed circle 23a within the optically utilized region 20, in accordance with the data from FIG. 5, has to ensure high reflectivity values both for a maximum angle of incidence of 21° and for a minimum angle of incidence of approximately 10°. In this case, the minimum angle of incidence of approximately 10° results from the maximum angle of incidence of 21° from FIG. 5 on account of the interval length of 11°. The locations on the dashed circle at which the two abovementioned extreme values of the angles of incidence occur are emphasized in FIG. 6 by the tip of the arrow 26 for the angle of incidence of 10° and by the tip of the arrow 25 for the angle of incidence of 21°.

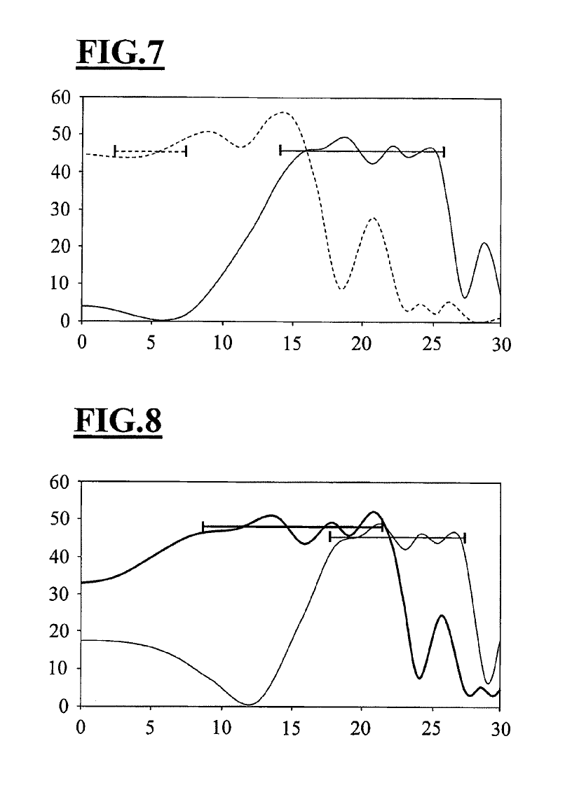

Since a layer arrangement cannot be varied locally over the locations of a substrate S without high technological outlay and layer arrangements are generally applied rotationally symmetrically with respect to the axis 9 of symmetry of the substrate, the layer arrangement along the locations of the dashed circle 23a in FIG. 6 comprises one and the same layer arrangement such as is shown in its basic construction in FIG. 1 or FIG. 2 and is explained in the form of specific exemplary embodiments with reference to FIGS. 7 to 10. In this case, it should be taken into consideration that a rotationally symmetrical coating of the substrate S with respect to the axis 9 of symmetry of the substrate S with the layer arrangement has the effect that the periodic sequence of the layer subsystems P′, P″ and P′″ of the layer arrangement is maintained at all locations of the mirror and only the thickness of the periods of the layer arrangement depending on the distance from the axis of symmetry acquires a rotationally symmetrical profile over the substrate S.

It should be taken into consideration that it is possible, with suitable coating technology, for example by the use of distribution diaphragms, to adapt the rotationally symmetrical radial profile of the thickness of a coating over the substrate. Consequently, in addition to the design of the coating per se, with the radial profile of the so-called thickness factor of the coating design over the substrate, a further degree of freedom is available for optimizing the coating design.

The reflectivity values illustrated in FIGS. 7 to 10 were calculated using the complex refractive indices n=n−i*k indicated in table 2 for the utilized materials at the wavelength of 13.5 nm. In this case, it should be taken into consideration that reflectivity values of real mirrors can turn out to be lower than the theoretical reflectivity values illustrated in FIGS. 7 to 10, since in particular the refractive indices of real thin layers can deviate from the literature values mentioned in table 2.

TABLE 2
Employed refractive indices n = n − i * k for 13.5 nm

| | Chemical | Layer design | | |
|---|---|---|---|---|
| Material | symbol | symbol | n | k |
| Substrate | | | 0.973713 | 0.0129764 |
| Silicon | Si | H, H′, H″, H′″ | 0.999362 | 0.00171609 |
| Boron carbide | B₄C | B | 0.963773 | 0.0051462 |
| Molybdenum | Mo | L, L′, L″, L′″ | 0.921252 | 0.0064143 |
| Ruthenium | Ru | M, L, L′, L″, L′″ | 0.889034 | 0.0171107 |
| Vacuum | | | 1 | 0 |

Moreover, the following short notation in accordance with the layer sequence with respect to FIG. 1 and FIG. 2 is declared for the layer designs associated with FIGS. 7 to 10:

Substrate/ . . . /(P₁)*N₁/(P₂)*N₂/(P₃)*N₃/covering layer system C where

### P1=H′ B L′ B; P2=H″ B L″ B; P3=H′″ B L′″ B; C=H B L M

In this case, the unit [nm] applies to the thicknesses of the individual layers that are specified between the parentheses. The layer design used with respect to FIGS. 7 and 8 can thus be specified as follows in the short notation:

Substrate/ . . . /(4.737 Si 0.4 B₄C 2.342 Mo 0.4 B₄C)*28/(3.443 Si 0.4 B₄C 2.153 Mo 0.4 B₄C)*5/(3.523 Si 0.4 B₄C 3.193 Mo 0.4 B₄C)*15/2.918 Si 0.4 B₄C 2 Mo 1.5 Ru

Since the barrier layer B₄C in this example is always 0.4 nm thick, it can also be omitted with the declaration that a 0.4 nm thick barrier layer composed of B₄C is situated between each of the Mo and Si layers specified hereinafter. Consequently, the layer design with respect to FIGS. 7 and 8 can be specified in a manner shortened as follows:

### Substrate/ . . . /(4.737 Si 2.342 Mo)*28/(3.443 Si 2.153 Mo)*5/(3.523 Si 3.193 Mo)*15/2.918 Si 2 Mo 1.5 Ru

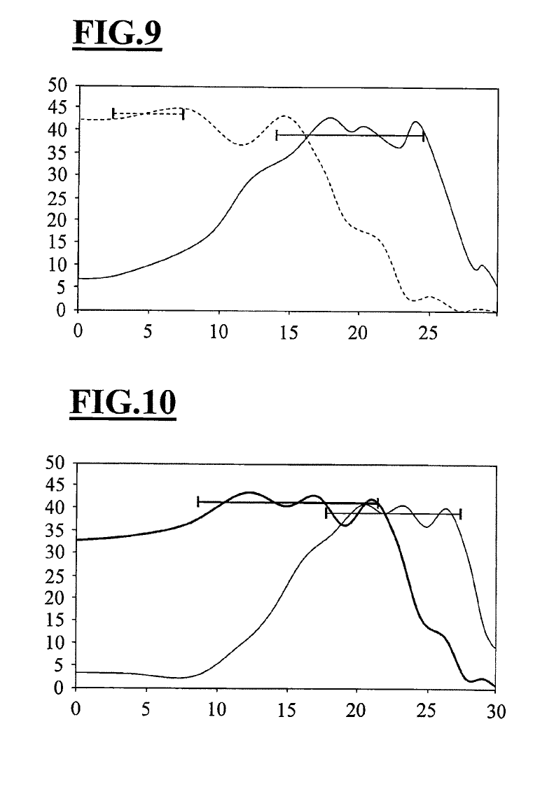

Correspondingly, the layer design used with respect to FIGS. 9 and 10 can be specified in the short notation as:

### Substrate/ . . . /(1.678 Si 0.4 B₄C 5.665 Mo 0.4 B₄C)*27/(3.798 Si 0.4 B₄C 2.855 Mo 0.4 B₄C)*14/1.499 Si 0.4 B₄C 2 Mo 1.5 Ru

Since the barrier layer B₄C is in turn always 0.4 nm thick in the case of this layer design, the shortened short notation with the abovementioned declaration can also be used for this layer design:

### Substrate/ . . . /(1.678 Si 5.665 Mo)*27/(3.798 Si 2.855 Mo)*14/1.499 Si 2 Mo 1.5 Ru

FIG. 7 shows the reflectivity values for unpolarized radiation in the unit [%] of the first exemplary embodiment of a mirror 1 according to the invention in accordance with FIG. 1 plotted against the angle of incidence in the unit [°]. In this case, the first layer subsystem P′ of the layer arrangement of the mirror 1 consists of N₁=28 periods P₁, wherein the period P₁ consists of 4.737 nm Si as high refractive index layer and 2.342 nm Mo as low refractive index layer, but also of two barrier layers each comprising 0.4 nm B₄C. The period P₁ consequently has a thickness d₁ of 7.879 nm. The second layer subsystem P″ of the layer arrangement of the mirror 1 consists of N₂=5 periods P₂, wherein the period P₂ consists of 3.443 nm Si as high refractive index layer and 2.153 nm Mo as low refractive index layer, and also of two barrier layers each comprising 0.4 nm B₄C. The period P₂ consequently has a thickness d₂ of 6.396 nm. The third layer subsystem P′″ of the layer arrangement of the mirror 1 consists of N₃=15 periods P₃, wherein the period P₃ consists of 3.523 nm Si as high refractive index layer and 3.193 nm Mo as low refractive index layer, and also of two barrier layers each comprising 0.4 nm B₄C. The period P₃ consequently has a thickness d₃ of 7.516 nm. The layer arrangement of the mirror 1 is terminated by a covering layer system C consisting of 2.918 nm Si, 0.4 nm B₄C, 2 nm Mo and 1.5 nm Ru in the order specified. Consequently, the layer subsystem P′″ that is most distant from the substrate has a number N₃ of periods P₃ that is greater than the number N₂ of periods P₂ for the layer subsystem P″ that is second most distant from the substrate.

The reflectivity values of this nominal layer design with the thickness factor 1 in the unit [%] at a wavelength of 13.5 nm are illustrated as a solid line against the angle of incidence in the unit [°] in FIG. 7. Moreover, the average reflectivity of this nominal layer design for the angle of incidence interval of 14.1° to 25.7° is depicted as a solid horizontal bar. Furthermore, FIG. 7 correspondingly specifies, at a wavelength of 13.5 nm and given a thickness factor of 0.933, as a dashed line the reflectivity values against the angles of incidence and as a dashed bar the average reflectivity of the above-specified layer design for the angle of incidence interval of 2.5° to 7.3°. Consequently, the thicknesses of the periods of the layer arrangement with respect to the reflectivity values illustrated as a dashed line in FIG. 7 amount to only 93.3% of the corresponding thicknesses of the periods of the nominal layer design. In other words, the layer arrangement is thinner than the nominal layer design by 6.7% at the mirror surface of the mirror 1 at the locations at which angles of incidence of between 2.5° and 7.3° have to be ensured.

FIG. 8 shows, at a wavelength of 13.5 nm and given a thickness factor of 1.018, in a manner corresponding to FIG. 7, as a thin line the reflectivity values against the angles of incidence and as a thin bar the average reflectivity of the above-specified layer design for the angle of incidence interval of 17.8° to 27.2°, and also, given a thickness factor of 0.972, in a corresponding manner, as a thick line the reflectivity values against the angles of incidence and as a thick bar the average reflectivity of the above-specified layer design for the angle of incidence interval of 14.1° to 25.7°. Consequently, the layer arrangement is thicker than the nominal layer design by 1.8% at the mirror surface of the mirror 1 at the locations at which angles of incidence of between 17.8° and 27.2° have to be ensured and is correspondingly thinner than the nominal layer design by 2.8% at the locations at which angles of incidence of between 14.1° and 25.7° have to be ensured.

The average reflectivity and PV values which can be achieved with the layer arrangement with respect to FIG. 7 and FIG. 8 are compiled relative to the angle of incidence intervals and the thickness factors in table 3. It can be discerned that the mirror 1 comprising the layer arrangement specified above, at a wavelength of 13.5 nm for angles of incidence of between 2.5° and 27.2°, has an average reflectivity of more than 45% and a variation of the reflectivity as PV value of less than or equal to 0.23.

TABLE 3
average reflectivity and PV values of the layer design with respect to
FIG. 7 and FIG. 8 relative to the angle of incidence interval in degrees and
the thickness factor chosen.

| AOI Interval | Thickness | R_average | |
|---|---|---|---|
| [°] | factor | [%] | PV |
| 17.8-27.2 | 1.018 | 45.2 | 0.17 |
| 14.1-25.7 | 1 | 45.7 | 0.23 |
| 8.7-21.4 | 0.972 | 47.8 | 0.18 |
| 2.5-7.3 | 0.933 | 45.5 | 0.11 |

FIG. 9 shows the reflectivity values for unpolarized radiation in the unit [%] of the second exemplary embodiment of a mirror 1 according to the invention in accordance with FIG. 2 plotted against the angle of incidence in the unit [°]. In this case, the layer subsystem P″ of the layer arrangement of the mirror 1 consists of N₂=27 periods P₂, wherein the period P₂ consists of 1.678 nm Si as high refractive index layer and 5.665 nm Mo as low refractive index layer, and also of two barrier layers each comprising 0.4 nm B₄C. The period P₂ consequently has a thickness d₂ of 8.143 nm. The layer subsystem P′″ of the layer arrangement of the mirror 1 consists of N₃=14 periods P₃, wherein the period P₃ consists of 3.798 nm Si as high refractive index layer and 2.855 nm Mo as low refractive index layer, and also of two barrier layers each comprising 0.4 nm B₄C. Consequently, the period P₃ has a thickness d₃ of 7.453 nm. The layer arrangement of the mirror 1 is terminated by a covering layer system C consisting of 1.499 nm Si, 0.4 nm B₄C, 2 nm Mo and 1.5 nm Ru in the order specified. Consequently, the layer subsystem P′″ that is most distant from the substrate has a thickness of the high refractive index layer H′″ that deviates by more than 0.1 nm from the thickness of the high refractive index layer H″ of the layer subsystem P″ that is second most distant from the substrate. In particular, in this case, the layer subsystem P′″ that is most distant from the substrate has a thickness of the high refractive index layer H′″ that amounts to more than double the thickness of the high refractive index layer H″ of the layer subsystem P″ that is second most distant from the substrate.

The reflectivity values of this nominal layer design with the thickness factor 1 in the unit [%] at a wavelength of 13.5 nm are illustrated as a solid line against the angle of incidence in the unit [°] in FIG. 9. Moreover, the average reflectivity of this nominal layer design for the angle of incidence interval of 14.1° to 25.7° is depicted as a solid horizontal bar. Furthermore, FIG. 9 correspondingly specifies, at a wavelength of 13.5 nm and given a thickness factor of 0.933, as a dashed line the reflectivity values against the angles of incidence and as a dashed bar the average reflectivity of the above-specified layer design for the angle of incidence interval of 2.5° to 7.3°. Consequently, the thicknesses of the periods of the layer arrangement with respect to the reflectivity values illustrated as a dashed line in FIG. 9 amount to only 93.3% of the corresponding thicknesses of the periods of the nominal layer design. In other words, the layer arrangement is thinner than the nominal layer design by 6.7% at the mirror surface of the mirror 1 at the locations at which angles of incidence of between 2.5° and 7.3° have to be ensured.

FIG. 10 shows in a manner corresponding to FIG. 9, at a wavelength of 13.5 nm and given a thickness factor of 1.018, as a thin line the reflectivity values against the angles of incidence and as a thin bar the average reflectivity of the above-specified layer design for the angle of incidence interval of 17.8° to 27.2°, and also, given a thickness factor of 0.972, in a corresponding manner, as a thick line the reflectivity values against the angles of incidence and as a thick bar the average reflectivity of the above-specified for the angle of incidence interval of 14.1° to 25.7°. Consequently, the layer arrangement is thicker than the nominal layer design by 1.8% at the mirror surface of the mirror 1 at the locations at which angles of incidence of between 17.8° and 27.2° have to be ensured and is correspondingly thinner than the nominal layer design by 2.8% at the locations at which angles of incidence of between 14.1° and 25.7° have to be ensured.

The average reflectivity and PV values which can be achieved with the layer arrangement with respect to FIG. 9 and FIG. 10 are compiled relative to the angle of incidence intervals and the thickness factors in table 4. It can be discerned that the mirror 1 comprising the layer arrangement specified above, at a wavelength of 13.5 nm for angles of incidence of between 2.5° and 27.2°, has an average reflectivity of more than 39% and a variation of the reflectivity as PV value of less than or equal to 0.22.

TABLE 4
average reflectivity and PV values of the layer design with respect to
FIG. 9 and FIG. 10 relative to the angle of incidence interval in degrees
and the thickness factor chosen.

| AOI Interval | Thickness | R_average | |
|---|---|---|---|
| [°] | factor | [%] | PV |
| 17.8-27.2 | 1.018 | 39.2 | 0.19 |
| 14.1-25.7 | 1 | 39.5 | 0.22 |
| 8.7-21.4 | 0.972 | 41.4 | 0.17 |
| 2.5-7.3 | 0.933 | 43.9 | 0.04 |

The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

1. A mirror configured for the extreme-ultraviolet (EUV) wavelength range comprising a layer arrangement applied on a substrate,
wherein the layer arrangement comprises a plurality of layer subsystems (P″, P′″) each consisting of a periodic sequence of at least one period (P₂, P₃) of individual layers,
wherein the periods (P₂, P₃) comprise two individual layers composed of different material providing a high refractive index layer (H″, H′″) and a low refractive index layer (L″, L′″) and have within each layer subsystem (P″, P′″) a constant thickness (d₂, d₃) that deviates from a thickness of the periods of an adjacent layer subsystem, and
wherein the mirror, at a wavelength of 13.5 nm, has a reflectivity of more than 35% and a variation of the reflectivity as PV value of less than or equal to 0.25 for an angle of incidence interval selected as an angle of incidence interval from the group of angle of incidence intervals: from 0° to 30°, from 17.8° to 27.2°, from 14.1° to 25.7°, from 8.7° to 21.4°, and from 2.5° to 7.3°.

2. A mirror configured for the extreme-ultraviolet (EUV) wavelength range comprising a layer arrangement applied on a substrate,
wherein the layer arrangement comprises a plurality of layer subsystems (P″, P′″) each consisting of a periodic sequence of at least one period (P₂, P₃) of individual layers,
wherein the periods (P₂, P₃) comprise two individual layers composed of different material providing a high refractive index layer (H″, H′″) and a low refractive index layer (L″, L′″) and have within each layer subsystem (P″, P′) a constant thickness (d₂, d₃) that deviates from a thickness of the periods of an adjacent layer subsystem, and
wherein at least one of:
the layer subsystem (P′″) that is most distant from the substrate has a number (N₃) of periods (P₃) that is greater than the number (N₂) of periods (P₂) for the layer subsystem (P″) that is second most distant from the substrate and the layer subsystem (P′″) that is most distant from the substrate has a thickness of the high refractive index layer (H′″) that deviates by more than 0.1 nm from the thickness of the high refractive index layer (H″) of the layer subsystem (P″) that is second most distant from the substrate.

3. The mirror for the EUV wavelength range according to claim 2, wherein the layer subsystems (P″, P′″) are constructed from the same materials.

4. The mirror for the EUV wavelength range according to claim 2, wherein the layer subsystem (P′″) that is most distant from the substrate has a thickness of the high refractive index layer (H′″) that is more than double the thickness of the high refractive index layer (H″) of the layer subsystem (P″) that is second most distant from the substrate.

5. The mirror for the EUV wavelength range according to claim 1, wherein the layer arrangement comprises at least three layer subsystems (P′, P″, P′″) and the number (N₁) of periods (P₁) of the layer subsystem (P′) that is situated closest to the substrate is at least one of: greater than for the layer subsystem (P′″) that is most distant from the substrate, and greater than for the layer subsystem (P″) that is second most distant from the substrate.

6. The mirror for the EUV wavelength range according to claim 1, wherein the number (N₃) of periods (P₃) of the layer subsystem (P′″) that is most distant from the substrate corresponds to a value of between 9 and 16.

7. The mirror for the EUV wavelength range according to claim 1, wherein the number (N₂) of periods (P₂) of the layer subsystem (P″) that is second most distant from the substrate corresponds to a value of between 2 and 12.

8. The mirror for the EUV wavelength range according to claim 1, wherein the thickness (d₃) of periods (P₃) for the layer subsystem (P′″) that is most distant from the substrate is between 7.2 nm and 7.7 nm.

9. The mirror for the EUV wavelength range according to claim 1, wherein the thickness of the high refractive index layer (H′″) of periods (P₃) for the layer subsystem (P′″) that is most distant from the substrate is greater than 3.4 nm.

10. The mirror for the EUV wavelength range according to claim 1, wherein the thickness of the low refractive index layer (L′″) of periods (P₃) for the layer subsystem (P′″) that is most distant from the substrate is less than two thirds of the thickness of the low refractive index layer (L″) of periods (P₂) for the layer subsystem (P″) that is second most distant from the substrate.

11. The mirror for the EUV wavelength range according to claim 1, wherein the thickness of the low refractive index layer (L″) of periods (P₂) for the layer subsystem (P″) that is second most distant from the substrate is greater than 5 nm.

12. The mirror for the EUV wavelength range according to claim 1, wherein the materials of the two individual layers forming the periods are molybdenum and silicon or ruthenium and silicon, and wherein the individual layers are separated by at least one barrier layer, and the barrier layer consists of a material which is selected from or a compound which is composed from the group of materials consisting of: B₄C, C, Si nitride, Si carbide, Si boride, Mo nitride, Mo carbide, Mo boride, Ru nitride, Ru carbide and Ru boride.

13. The mirror for the EUV wavelength range according to claim 1, wherein a covering layer system comprises at least one layer (M) composed of a chemically inert material and terminates the layer arrangement of the mirror.

14. The mirror for the EUV wavelength range according to claim 2, wherein the mirror, at a wavelength of 13.5 nm, has a reflectivity of more than 35% and a variation of the reflectivity as PV value of less than or equal to 0.25, for an angle of incidence interval selected as an angle of incidence interval from the group of angle of incidence intervals: from 0° to 30°, from 17.8° to 27.2°, from 14.1° to 25.7°, from 8.7° to 21.4°, and from 2.5° to 7.3°.

15. The mirror for the EUV wavelength range according to claim 1, wherein the variation of the reflectivity as PV value is less than or equal to 0.18.

16. The mirror for the EUV wavelength range according to claim 1, wherein a thickness factor of the layer arrangement along the mirror surface has a value of between 0.9 and 1.05.

17. The mirror for the EUV wavelength range according to claim 16, wherein the thickness factor of the layer arrangement at a location of the mirror surface correlates with the maximum angle of incidence at the mirror surface location.

18. The mirror for the EUV wavelength range according to claim 1, wherein the layer subsystems (P″, P′″) are constructed from the same materials, and wherein at least one of: the layer subsystem (P′″) that is most distant from the substrate has a number (N₃) of periods (P₃) that is greater than the number (N₂) of periods (P₂) for the layer subsystem (P″) that is second most distant from the substrate, and the layer subsystem (P′″) that is most distant from the substrate has a thickness of the high refractive index layer (H′″) that is more than double the thickness of the high refractive index layer (H″) of the layer subsystem (P″) that is second most distant from the substrate.

19. A projection objective for microlithography comprising a mirror according to claim 1.

20. A projection exposure apparatus for microlithography comprising a projection objective according to claim 19.

21. A projection objective for microlithography comprising a mirror according to claim 2.

22. A projection exposure apparatus for microlithography comprising a projection objective according to claim 21.

23. The mirror for the EUV wavelength range according to claim 2, wherein the layer arrangement comprises at least three layer subsystems (P′, P″, P′″) and the number (N₁) of periods (P₁) of the layer subsystem (P′″) that is situated closest to the substrate is at least one of: greater than for the layer subsystem (P′″) that is most distant from the substrate, and greater than for the layer subsystem (P″) that is second most distant from the substrate.

24. The mirror for the EUV wavelength range according to claim 2, wherein the number (N₃) of periods (P₃) of the layer subsystem (P′″) that is most distant from the substrate corresponds to a value of between 9 and 16.

25. The mirror for the EUV wavelength range according to claim 2, wherein the number (N₂) of periods (P₂) of the layer subsystem (P″) that is second most distant from the substrate corresponds to a value of between 2 and 12.

26. The mirror for the EUV wavelength range according to claim 2, wherein the thickness (d₃) of periods (P₃) for the layer subsystem (P′″) that is most distant from the substrate is to between 7.2 nm and 7.7 nm.

27. The mirror for the EUV wavelength range according to claim 2, wherein the thickness of the high refractive index layer (H′″) of periods (P₃) for the layer subsystem (P′″) that is most distant from the substrate is greater than 3.4 nm.

28. The mirror for the EUV wavelength range according to claim 2, wherein the thickness of the low refractive index layer (L′″) of periods (P₃) for the layer subsystem (P′″) that is most distant from the substrate is less than two thirds of the thickness of the low refractive index layer (L″) of periods (P₂) for the layer subsystem (P″) that is second most distant from the substrate.

29. The mirror for the EUV wavelength range according to claim 2, wherein the thickness of the low refractive index layer (L″) of periods (P₂) for the layer subsystem (P″) that is second most distant from the substrate is greater than 5 nm.

30. The mirror for the EUV wavelength range according to claim 2, wherein the materials of the two individual layers forming the periods are molybdenum and silicon or ruthenium and silicon, and wherein the individual layers are separated by at least one barrier layer, and the barrier layer consists of a material which is selected from or a compound which is composed from the group of materials consisting of: B₄C, C, Si nitride, Si carbide, Si boride, Mo nitride, Mo carbide, Mo boride, Ru nitride, Ru carbide and Ru boride.

31. The mirror for the EUV wavelength range according to claim 2, wherein a covering layer system comprises at least one layer (M) composed of a chemically inert material and terminates the layer arrangement of the mirror.
